(19) United States
(12) Patent Application Publication
(10) Pub. No.: US 2011/0097471 A1
(43) Pub. Date: Apr. 28, 2011

(54) METHOD FOR MAKING FLAKED SHORTENING, FLAKED SHORTENING COMPOSITIONS, AND DOUGH COMPOSITIONS

(76) Inventor: Mark E. Arlinghaus, Minneapolis, MN (US)

(21) Appl. No.: 12/908,928

(22) Filed: Oct. 21, 2010

Related U.S. Application Data
(60) Provisional application No. 61/254,487, filed on Oct. 23, 2009.

(51) Int. Cl. A23D 9/04; A23D 9/00; A21D 10/00

(52) U.S. Cl. 426/549; 426/417; 426/606

(57) ABSTRACT

Disclosed are methods of making flaked shortening compositions, flaked shortening composition prepared using the disclosed methods, and dough compositions incorporating the flaked shortening compositions. The methods comprise the steps of: (a) providing a shortening composition at a temperature above its melting point so that it is a liquid; (b) rapidly cooling the liquid shortening composition to form a supercooled shortening composition; (c) extruding the supercooled shortening composition through an orifice to form an extrudate comprising the supercooled shortening composition; and (d) allowing the supercooled shortening composition to complete crystallization to form the flaked shortening composition.

### CROSS-REFERENCE TO RELATED APPLICATIONS

This application claims the benefit of priority under 35 U.S.C. 119(e)(1) of U.S. provisional patent application Ser. No. 61/254,487, filed Oct. 23, 2010, the disclosure of which is incorporated herein by reference.

### BACKGROUND

Flaked shortening compositions are commonly used in the preparation of certain baked dough articles, such as Pillsbury Grands!® Biscuits. Typically, the flaked shortening compositions comprise a plurality of discrete particles of shortening that typically range from about 0.02 to about 0.5 grams. Commonly, flaked shortening compositions are prepared by melting a shortening composition and applying the melted composition to a chilled rotating drum. As the drum rotates, the melted composition solidifies on the surface of the drum and the solidified composition is scraped from the drum to form a plurality of flaked shortening particles. The flaking apparatuses are expensive; typically adding a cost per pound to flaked shortening of about 7 to 11 cents over the cost of bulk liquid oil. In view of the foregoing, what is desired is a new more cost-effective method for preparing flaked shortening compositions.

### SUMMARY

The present invention relates to methods for making flaked shortening compositions, flaked shortening composition prepared in accordance with the disclosed methods, and to dough compositions prepared using the flaked shortening compositions. In some embodiments, the methods of the invention provide flaked shortening compositions that, as compared to other extruded flaked shortening compositions, are more brittle and display less smearing when incorporated into a dough composition during mixing. In some embodiments, the flaked shortening compositions of the invention can be prepared using equipment that is less expensive than traditional flaking drums and belts. Also, the output capacity of the equipment is not affected by the final thickness of the pieces of flaked shortening. Traditional flaking processes must slow down in order to make thicker flakes. The elimination of a resting tube from the equipment further reduces the size and cost of the equipment used to prepare the flaked shortening composition.

In one aspect, the invention relates to a method of making flaked shortening compositions. The method comprises the steps of: (a) providing a shortening composition at a temperature above its melting point so that it is a liquid; (b) rapidly cooling the liquid shortening composition to form a supercooled shortening composition; (c) extruding the supercooled shortening composition through an orifice to form an extrudate comprising the supercooled shortening composition; and (d) allowing the supercooled shortening composition to complete crystallization to form the flaked shortening composition.

In another aspect, the invention relates to a flaked shortening composition prepared by a method comprising the steps of: (a) providing a shortening composition at a temperature above its melting point so that it is a liquid; (b) rapidly cooling the liquid shortening composition to form a supercooled shortening composition; (c) extruding the supercooled shortening composition through an orifice to form an extrudate comprising the supercooled shortening composition; and (d) allowing the supercooled shortening composition to complete crystallization to form the flaked shortening composition.

In yet another aspect, the invention relates to dough compositions prepared using the flaked shortening compositions of the invention.

### BRIEF DESCRIPTION OF THE FIGURES

FIG. 1 is a process diagram illustrating an embodiment of the present invention.

FIG. 2 is a process diagram illustrating an embodiment of the present invention.

### DETAILED DESCRIPTION

The present invention relates to methods for making flaked shortening compositions, flaked shortening composition prepared in accordance with the disclosed methods, and to dough compositions prepared with the flaked shortening compositions.

The flaked shortening compositions of the invention comprise a plurality of discrete fat pieces that are individually separate and distinct from one another. The pieces may have any desired shape, for example, chips, flakes, rods, spheres, and other geometries. At room temperature, the individual fat pieces making up the fat piece composition do not adhere to one another to an appreciable degree. This allows the flaked shortening compositions to be handled, dispensed, and applied to a dough composition as individual particles, rather than as a solid. In many embodiments, the flakes have a thickness of about 0.02 inches to about 0.5 inches (0.51 mm to 12.7 mm), more typically ranging from about 0.03 inches to about 0.2 inches (0.76 mm to 5.1 mm), and preferably in the range of about 0.04 inches to about 0.08 inches (1.0 mm to 2.0 mm). Pieces with round cross section have diameters ranging from about 0.04 inches to about 0.5 inches (1 mm to 12.7 mm), more typically from about 0.05 inches to about 0.2 inches (1.3 mm to 5.1 mm), and preferably from about 0.07 inches to about 0.15 inches (1.8 mm to 3.8 mm).

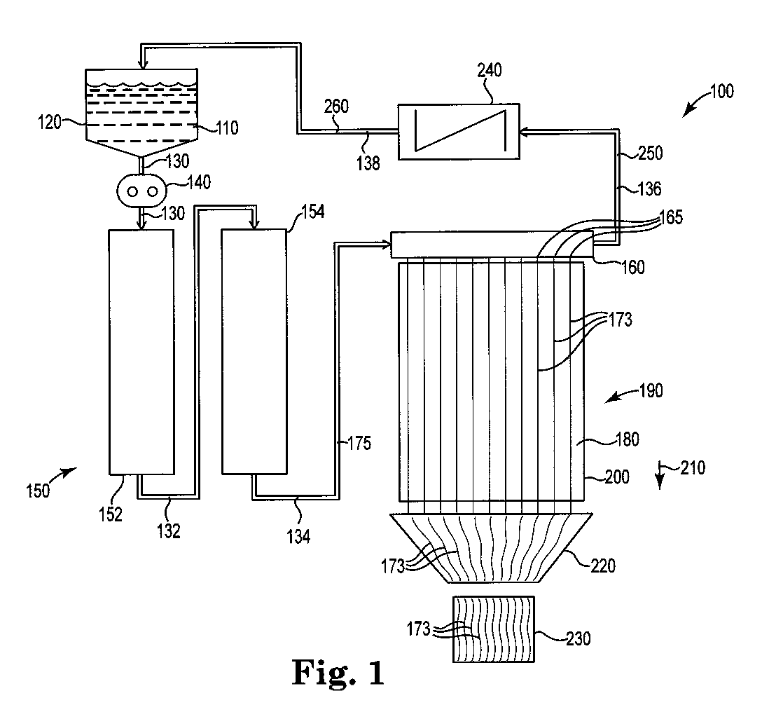

Referring now to FIG. 1, a typical method of the invention is shown. In method 100, shortening composition 110 is initially held in heated storage tank 120. The shortening composition 110 is held at a temperature that is greater than the melting point of the shortening composition so that it is present in the storage tank 120 as a liquid. Depending upon the ingredients making up the shortening composition, the shortening composition may be held at a temperature of about 100 F (37.8° C.) or greater, for example, about 110° F. (43.3° C.) or greater, or about 150° F. (65.6° C.) or greater. In method, pump 140 causes the liquid shortening composition 110 to flow from storage tank 120 to heat exchanger 150 through conduit 130. Heat exchanger 150 may include one or more separate pieces of processing equipment that are connected in series or parallel fashion. In FIG. 1, heat exchanger 150 is made up of two separate scraped-surface heat exchangers 152 and 154 that are connected in series by conduit 132. While in the heat exchanger 150, the shortening composition is rapidly cooled to a temperature that is below its Mettler Drop Point. For example, the liquid shortening composition may be cooled to about 60° F. (15.6° C.) or less, or about 40° F. (4.4° C.) or less below the drop point of the shortening composition. The rapid cooling causes shortening composition to become a supercooled liquid. As used herein the term “supercooled liquid” means that the shortening composition is cooled to a temperature below its melting point while remaining as a liquid.

As described above, the shortening composition may be supercooled by passing through one or more scraped-surface heat exchangers. Supercooling is favored when the rate of energy removal from the shortening is high and the residence time in the heat exchangers is short. Useful scraped-surface heat exchangers are designed and operated in order to provide a high heat transfer between the shortening composition and the refrigerant in order to rapidly cool the shortening composition. Factors favoring a high heat transfer rates in a scraped-surface heat exchanger include, for example, a low temperature refrigeration medium (e.g., −10° F. (−23.3° C.) or less) and highly conductive heat exchanger barrels made of either thin walled stainless steel or chromed nickel. By way of example, in a representative embodiment the scraped surface heat exchanger is capable of cooling a shortening composition from an initial temperature of about 105° F. (40.6° C.) or greater to a final temperature of about 65° F. (18.3° C.) or less in a time period of about 15 seconds. Scraped-surface heat exchangers useful in the method of the invention are commercially available, for example, from Chemtech (Vitorio Venito, Italy).

Upon exiting heat exchanger 154, the supercooled shortening composition 175 is then fed through conduit 134 into a distribution manifold 160. The total residence time from the outlet of the scraped surface heat exchanger to the inlet of the manifold is kept below about 60 seconds, preferably below about 30 seconds to minimize crystal formation. The manifold is constructed to reduce internal volume as well. The total elapsed time from the outlet of the heat exchanger to the outlet of the manifold is less than about 90 seconds, more typically less than about 60 seconds. At this point the material may be a low viscosity liquid or a high viscosity liquid with a discernable yield stress. In either case, the short residence time provides that some uncrystallized material passes through the outlet of the manifold. This material completes crystallization downstream without undergoing further shear. This results in a brittle flake that displays less tendency to smear when incorporated into a dough composition. As used herein the term “smear” refers to the tendency of certain flaked shortening particles to wear away at the edges during the dough mixing operation which can cause the smeared-in fat to be finely distributed throughout the dough composition much like a liquid shortening. The observation of a 5° F. (−15° C.) or preferably a 10° F. (−12.2° C.) temperature rise in the material within the first hour of its extrusion confirms the presence of uncrystallized material at the exit of the distribution manifold. The distribution manifold 160 includes one or more shaped orifices 165 for shaping the supercooled shortening composition 175 into one or more extrudate(s) 173 having the desired shape and form. Typically, the extrudate(s) 173 of the supercooled shortening composition 175 are divided into a series of two or more, typically 5 or more, thin sheets or ribbons. Typically, the extrudate(s) 173 have a thickness of about 0.06 inches (1.5 mm) or less, and a width of about 0.2 inches (5.1 mm) to about 1 inch (25, 4 mm), although other widths, thicknesses, and profiles may also be useful, for example, continuous sheets up to several feet wide. In some embodiments, the extrudate(s) 173 have a cross-sectional shape that is oval, circular, elliptical, and the like. Other shapes are also within the scope of the invention. In the embodiment shown in FIG. 1, the extrudate(s) 173 are extruded onto the surface 180 of an aging conveyor 190. The aging conveyor 190 includes a moving belt 200 that moves in a direction 210 away from the distribution manifold 160 in order to carry the extrudate(s) 173 of supercooled shortening composition away from the distribution manifold 160. The moving belt 200 carries the extrudate(s) 173 of supercooled shortening composition 175 to a packaging and weighing station 210 where the extrudate(s) 173 are collected and weighed in weighing system 220, and are then boxed in box or tote 230. Optionally, system 100 may further include a re-melt heat exchanger 240 that is connected to distribution manifold 160 by conduit 136. The re-melt heat exchanger 240 melts the recycled shortening composition 250 from the distribution manifold 160 and feeds the re-melted shortening composition 260 into storage tank 120 through conduit 138.

In embodiments of the method of the invention, the supercooled shortening composition of extrudate(s) 173 completes solidification while in contact with the moving belt 200 of aging conveyor 190. Crystallization of the supercooled shortening composition is an exothermic process (i.e., a process that results in the release of heat within the shortening composition as crystallization occurs). Because of the exothermic nature of the crystallization process, the shortening composition is preferably supercooled to a temperature that is sufficiently below the melting point of shortening composition low enough so that the release of the heat of crystallization does not cause the shortening composition to become soft. Typically, the shortening composition is supercooled to a temperature that is about 40° F. (4.4° C.) below the drop point of the shortening composition. For example, if the shortening composition has a melting point of about 105° F. (40.6° C.), then it is typically supercooled to a temperature of about 65° F. (18.3° C.) or lower.

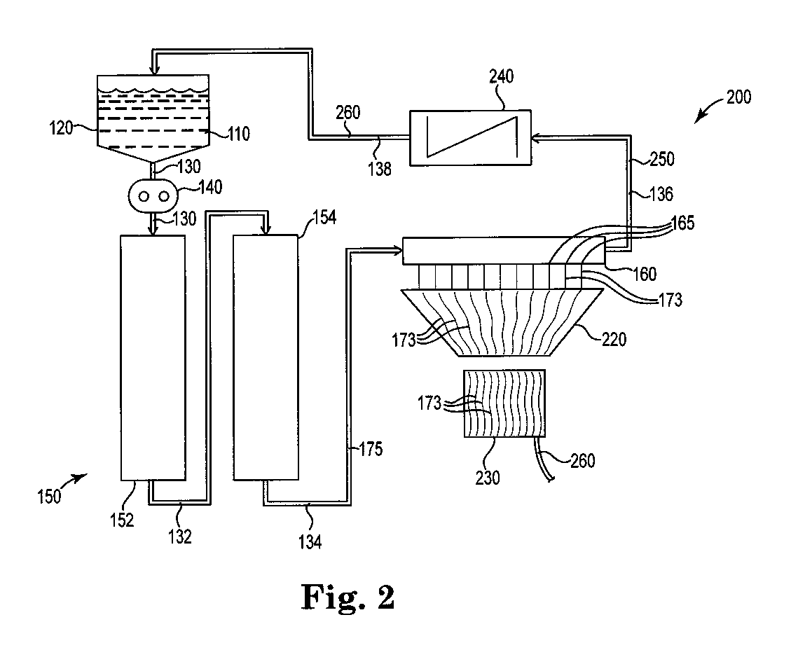

In an alternative embodiment, as shown in FIG. 2, the method 200 includes a direct extrusion of the shortening composition 175 into a container 230 (e.g., cardboard box or tote). In method 200, shortening composition 175 is extruded in the form of extrudate(s) 173 from the distribution manifold 160 directly into a container 230 where it is allowed to complete crystallization to form the flaked shortening composition. In some embodiments, the shortening composition is cooled while in the shipping container by blowing a stream of air through the box. For example, as shown in FIG. 2, an air hose 260 can be inserted into the box 230 in order to direct a stream of cold air, preferably 50° F. (10° C.) or less, through the box to provide a cooling effect to the extrudate(s) 173.

Suitable shortening compositions for use in the method of the invention are solid at approximately room temperature. Typically, the Mettler Drop Point of the shortening composition ranges from about 95° F. to about 140° F. (35° C. to 60° C.).

In some embodiments, the shortening composition may be referred to as “low trans”. The low trans shortening compositions contain a reduced amount of trans fatty acids as compared to previously known fat pieces. For example, the low trans shortening compositions may contain about 50% wt. or less trans fatty acids, for example, about 25% wt. or less trans fatty acids. In many embodiments, the low trans shortening composition comprises: (i) a base oil, (ii) a hardstock fat, (iii) an emulsifier, (iv) salt, (v) water, and (vi) may optionally further comprise a hydrocolloid.

In some embodiments, the shortening composition may be referred to as “trans free”. In many embodiments, the trans free shortening contains about 4% wt. or less trans fatty acids. In many embodiments, the trans-free shortening comprises: (i) a base oil, (ii) a hardstock fat, (iii) an emulsifier, (iv) a hydrocolloid, (v) water, and (vi) may optionally further comprise a water activity modifier (e.g., salt).

The ingredients making up the shortening composition are described in more detail below.

In some embodiments, the shortening compositions comprise one or more base oils. Useful base oils typically comprise fatty acid esters of glycerol, for example, monoglycerides, diglycerides, and triglycerides. Examples of base oils include natural or genetically modified soybean oil, corn oil, canola oil, copra oil, cottonseed oil, peanut oil, safflower oil, olive oil, sunflower oil, peanut oil, palm oil, palm kernel oil, coconut oil, rice bran oil, rapeseed oil, other vegetable nut/seed oils, partially hydrogenated vegetable oils, and mixtures thereof. Also useful are butter, lard, tallow, fish oils, fatty acids, and triglycerides that are derived from microorganisms, animals, and plants. Interesterified oils prepared from any of the foregoing base oils may also be useful. Mixtures of any of the foregoing base oils may also be useful.

In an exemplary low trans fat embodiment, the base oil comprises partially hydrogenated soybean oil, for example, having an iodine value (IV) ranging from about 50 to about 90. Trans fat refers to a monoglyceride, diglyceride, or triglyceride molecule that contains at least one esterified fatty acid molecule that has a trans configuration (i.e., a trans fatty acid). Trans fatty acids may be formed, for example, during hydrogenation of unsaturated fatty acids. A partially-hydrogenated soybean oil typically contains about 15% wt. to about 50% wt. trans fatty acids.

In an exemplary trans free embodiment, the base oil comprises refined, bleached, and deodorized (RBD) palm oil. Palm oil typically comprises about 50% saturated fatty acids and about 50% unsaturated fatty acids. The content of trans fatty acids can range from about 0 to about 4%.

In many embodiments, the base oil is present in an amount ranging from about 40% wt. to about 80% wt., or in an amount ranging from about 50% wt. to about 70% wt.

One useful base oil is available under the trade designation “106-150” from ADM. This base oil is a 100% soy interesterified shortening having 0 grams trans fat per serving and 4% trans fat maximum.

In many embodiments, the shortening composition comprises a hardstock fat. By hardstock fat it is meant that the fat is a solid at room temperature or very near room temperature. Hardstock fats typically have a melting point ranging from about 122° F. (50° C.) to about 176° F. (80° C.), or from about 140° F. (60° C.) to about 158° F. (70° C.).

In many embodiments the hardstock fat comprises glycerides of fatty acids such as monoglycerides, diglycerides, and triglycerides. The glycerides have a fatty acid composition that comprises a very high percentage of saturated fatty acids. The solid fat component can be very low in trans fatty acids, since only a very few of the fatty acids have residual sites of unsaturation.

Representative examples of hardstock fats include, for example, natural or genetically modified soybean oil, corn oil, canola oil, copra oil, cottonseed oil, peanut oil, safflower oil, olive oil, sunflower oil, peanut oil, palm oil, palm kernel oil, coconut oil, rice bran oil, rapeseed oil and other vegetable nut/seed oils, butter, partially hydrogenated vegetable oils and mixtures thereof, lard, tallow, fish oils, fatty acids and triglycerides derived from microorganisms, animals, and plants. These fats and oils may be non-hydrogenated, partially-hydrogenated, or fully-hydrogenated.

In some embodiments, the hardstock fat is produced by hydrogenating the unsaturated fatty acids that are present in a vegetable oil in order to increase the amount of saturated fatty acids that are present in the vegetable oil. Techniques for hydrogenation of vegetable oils are known in the art and include, for example, reacting a vegetable oil having unsaturated fatty acids with hydrogen gas in the presence of a hydrogenation catalyst, for example, a supported nickel catalyst. The hydrogenated vegetable oil may be fully-hydrogenated in order to achieve an iodine value (IV) of about 10 or less, or about 5 or less. Representative hydrogenated solid fats include hydrogenated cottonseed oil, hydrogenated soybean oil, hydrogenated palm oil, palm oil, fully-hydrogenated palm kernel oil, fully-hydrogenated coconut oil, and mixtures thereof.

The hardstock fat or solid fat is typically present in the hydrated fat of the invention in an amount ranging from about 5% wt. to about 40% wt. In exemplary embodiments, the hardstock fat is present in an amount ranging from about 20% wt. to about 30% wt. For example, the solid fat may be fully hydrogenated cottonseed oil, which is present at 25% wt. of the hydrated fat composition.

Suitable fully-hydrogenated soybean oil flakes can be obtained commercially under the trade designation “DRITEX S FLAKES” (from ACH Food Companies, Inc. of Cordova, Tenn.). This frilly-hydrogenated soy oil has a melting point of about 165° F. (73.9° C.), and has an iodine value (IV) of between about 2 and about 5.

In some embodiments, the shortening composition comprises water that acts to hydrate the shortening composition. The water is dispersed throughout the solid portion of the shortening composition in the form of small water droplets. When present, the shortening composition typically comprises about 5% wt. to about 50% wt. water, or from about 20% wt. to about 40% wt. water. The presence of water in the shortening composition can provide one or more beneficial properties to a dough composition made using the shortening composition. For example, the presence of water reduces the total amount of fat that is present in the shortening composition. This allows the production of dough compositions that have a reduced total amount of fat as compared to dough compositions prepared with conventional non-hydrated shortening compositions. The presence of water is also advantageous since the water provides a leavening effect to the dough compositions during baking. Specifically, the water that is present in the shortening composition can vaporize under typical baking conditions to yield steam that provides a leavening effect to the dough composition. In addition, the presence of water may harden the fat pieces, which provides an advantage when used in dough compositions.

In some embodiments, the shortening composition comprises a hydrocolloid that serves as an emulsion stabilizer. Representative examples of hydrocolloids include agar, alginate, alginate+calcium, arabinoxylan, carrageenan, carrageenan+calcium, carboxymethylcellulose, cellulose, cellulose gum, cyclodextrins (in the presence of fat or other hydrophobic ligand), curdlan, gelatin, gellan, Li-Glucan, guar gum, gum arabic, and hydroxypropylmethylcellulose (HPMC), konjac locust bean gum, methyl cellulose, pectin, pectin+calcium, soybean soluble polysaccharide (SSP), starch, xantharn gum, and mixtures thereof. Preferred examples of hydrocolloids include agar, carrageenan, cellulose gum, locust bean gum, xanthan gum, and mixtures thereof. When included, the hydrocolloid is typically present in an amount ranging from about 0.01% wt. to about 0.30% wt., or in an amount ranging from about 0.05% wt. to about 0.15% wt.

In some embodiments, the shortening composition comprises a water activity modifier. The inclusion of a water activity modifier such as salt (e.g., NaCl) reduces the water activity (Aw) of the hydrated piece. For example, in some embodiments, the water activity may be reduced from about Aw=0.98 to about Aw=0.75. Water activity may be measured, for example, using a Series 3TE AquaLab Water Activity Meter (manufactured by Decagon Devices, Inc., Pullman Wash. 99163). The reduction of water activity is useful, for example, in order to reduce or eliminate condensate from collecting on the inside of plastic storage bags during storage and shipping of the flaked shortening compositions of the invention. Condensate may potentially present a microbial hazard. In some embodiments, the presence of salt (e.g., NaCl) also contributes to the formation of a harder shortening composition that has better production through-put than a formulation lacking this ingredient. Alternative water activity modifiers include, for example, MgCl₂, glycerol, pyrophosphate, sodium phosphate, etc. may be substituted for our used in addition to the NaCl.

In some embodiments, the shortening composition comprises one or more emulsifiers. Examples of emulsifiers include non-hydrogenated, partially- and fully-hydrogenated derivatives as well as fractions of the following classes of emulsifiers lecithins, mono and diglycerides, acid esters of mono and diglycerides (AMGS or alpha-monoglycerol stearate is a distilled monoglyceride of this class), di-acetyltartaric esters of monoglycerides (DATEM), polyglycerol esters, sucrose esters, sorbitan esters, polysorbates, propylene glycol fatty acid esters, stearoyl-2-lactylates, oleoyl lactylates, ammonium phosphatides, silicates, and mixtures thereof. One useful emulsifier blend comprises polyglycerol polyricinoleate (PGPR is a polyglycerol ester of castor oil fatty acids) and distilled monoglycerol of about 10% monopalmitin and about 90% monostearin. PGPR may be obtained, for example, under the trade designation “DREWPOL PGPR” (from Stepan Co.) or “GRINDSTED PGPR 90” (from Danisco Co.). Distilled monoglycerol may be obtained, for example, under the trade designation “ALPHADIM DBK” (from Caravan Ingredients) or “DIMODAN HS K-A” (from Danisco Co.). The emulsifier or emulsifier blend is typically present in the shortening composition in an amount ranging from about 0.10% wt. to about 5.0% wt.

The flaked shortening compositions of the invention may be used to prepare various dough compositions and dough articles. The dough compositions typically comprise flour, water, one or more leavening agents, and may also include optional ingredients.

The dough compositions typically comprise flour and may optionally include one or more other types of flour. The dough compositions typically comprise about 15 wt. % or greater flour based on the total weight of the dough composition. Wheat flour may be obtained commercially from such sources as ADM Milling; Bay State Milling Co.; Conagra Inc.; General Mills, Inc.; Horizon Milling, LLC; and Rohstein Corp.

Dough compositions of the invention include liquid components, for example, water, milk, eggs, and oil, or any combination of these. Water is typically present in dough compositions of the invention to provide the dough composition with the desired rheology. Water may be added during processing in the form of ice, to control the dough temperature during processing; the amount of any such water used is included in the amount of liquid components. The precise amount of water depends on factors known to those skilled in the dough making art including, for example, whether the dough composition is a developed or under-developed composition.

Water is typically present in dough compositions of the invention in an amount of about 15 wt. % or greater. In developed compositions, the amount of water from all sources, for example, water, eggs, milk, etc. should not be so high that the dough composition becomes soft and cannot maintain its desired closed-cell structure including bubbles of carbon dioxide and water vapor. Also, the amount of water should not be so low that the dough composition is dry and has no ability to expand.

The dough compositions can be caused to expand (leaven) by any leavening mechanism, such as by one or more of the effects of entrapped gas, such as entrapped carbon dioxide, entrapped oxygen, or both; by action of chemical leavening agents; or by action of a biological agent, such as a yeast. Thus, a leavening agent may be an entrapped gas, such as layers or cells (bubbles) that contain carbon dioxide, water vapor, or oxygen, etc.; any type of yeast (e.g., cake yeast, cream yeast, dry yeast, etc.); or a chemical leavening system (e.g., containing a basic chemical leavening agent and an acidic chemical leavening agent that react to form a leavening gas, such as carbon dioxide).

Dough compositions of the invention are typically yeast-leavened. As used herein the term “yeast-leavened” refers to dough compositions that are leavened primarily due to the production of gaseous metabolites of yeast; chemical leavening agents may optionally be present, but in minor amounts, preferably less than about 10% wt chemical leavening agent based on the total weight of the leavening agent (yeast and chemical leavening agent) or may not be present at all.

The yeast may be any suitable yeast known to those of skill in the art, for example, fresh cream/liquid yeast, fresh compressed yeast, active dry yeast, and instant yeast. In some embodiments, the yeast is fresh compressed yeast (e.g., in cake or crumbled form) comprising about 65% to about 75% water and about 25% to about 35% yeast. The amount of yeast can be an amount that will produce a desired volume of gaseous metabolites, as known to one of skill in the art. Typically, the amount of yeast present in the dough composition is up to about 10% wt (e.g., about 2% wt to about 8% wt for developed dough compositions, and less than about 1% wt to about 5% wt for under-developed compositions).

In some embodiments a chemical leavening agent may be used in addition to yeast. Acidic chemical leavening agents (or acid agents) that may be useful include those generally known in the dough and bread-making arts. Acidic agents may be relatively soluble within different temperature ranges and may or may not be encapsulated. Examples of acidic agents include sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dehydrate (DCPD), glucono-delta-lactone (GDL), an others. Commercially available acidic chemical leavening agents include those sold under the trade designations “LEVN-LITE” (SALP); “PAN-O-LITE” (SALP+MCP); “STABIL-9” (SALP+AMPC); “PY-RAN” (AMCP); and “HT MCP” (MCP).

The dough composition may also include an encapsulated basic chemical leavening agents. Useful basic chemical leavening agents are known in the dough and bread-making arts, and include soda (i.e., sodium bicarbonate, NaHCO₃), potassium bicarbonate (KHCO₃), ammonium bicarbonate (NH₄HCO₃), etc. Encapsulating the basic chemical leavening agent provides separation between the basic agent and the bulk of the dough composition. If present, chemical leavening agents typically comprises less than about 1% wt of the dough composition (e.g., less than about 0.5% wt. or less than about 0.3% wt.).

Dough compositions of the invention may optionally include one or more fat components that are added to the dough composition at the time the dough is prepared and are substantially interspersed and distributed throughout the dough composition. The amount of fat in the dough product due to the mixed-in fat component will depend upon the type of dough composition being prepared, but will typically be about 10% wt or less (e.g., about 1% to about 5% wt; or about 2% to about 3% wt). The type of fat in a dough composition of the invention is not particularly limited, and may be derived from vegetable, dairy and marine sources including butter oil or butterfat, soybean oil, corn oil, rapeseed or canola oil, copra oil, cottonseed oil, fish oil, safflower oil, olive oil, sunflower oil, peanut oil, palm oil, palm kernel oil, coconut oil, rice bran oil and other plant derived oils, such as vegetable or nut oils. Examples of shortenings include animal fats, such as lards, butter and hydrogenated vegetable oils, such as margarine. Mixtures of different fats may also be used.

The dough composition may optionally include one or more sweeteners, natural or artificial, liquid or dry. If a liquid sweetener is used, the amount of other liquid components may be adjusted accordingly. Examples of suitable dry sweeteners include lactose, sucrose, fructose, dextrose, maltose, corresponding sugar alcohols, and mixtures thereof. Examples of suitable liquid sweeteners include high fructose corn syrup, malt, and hydrolyzed corn syrup. Often, dough compositions include up to about 8% wt sweetener.

The dough composition may optionally include additional flavorings, for example, salt, such as sodium chloride and/or potassium chloride; whey; malt; yeast extract; inactivated yeast; spices; vanilla; natural and artificial flavors; etc.; as is known in the dough product arts. The additional flavoring can typically be included in an amount in the range from about 0.1% wt to about 10% wt of the dough composition (e.g., from about 0.2% wt to about 5% wt of the dough composition.

The dough composition may optionally include particulates, such as raisins, currants, fruit pieces, nuts, seeds, vegetable pieces, and the like, in suitable amounts.

The dough composition may optionally include other additives, colorings, and processing aids, for example, gliadin (e.g., less than about 1% to improve extensibility in under-developed dough), emulsifiers include lecithin, diglycerides, polyglycerol esters, and the like, (e.g., diacetylated tartaric esters of monoglyceride (DATEM) and sodium stearoyl lactylate (SSL)).

In many embodiments, the flaked shortening compositions are used to prepare laminated dough compositions. Typically, a laminated dough can be prepared by the steps of (a) providing a layer of a dough composition comprising flour and water; (b) applying a flaked shortening composition of the invention to a surface of the dough layer; (c) repeatedly folding and compressing (i.e., sheeting) the dough layer to form a laminated dough comprising a plurality of layers of dough separated by layers of hydrated fat.

The flaked shortening compositions of the invention may also be used in non-laminated dough compositions.

The invention will now be described with reference to the following non-limiting Examples.

### EXAMPLES

In this example, the shortening composition was partially hydrogenated soy shortening having a Mettler Dropping point of 100° F. (37.8° C.) and an SFC curve as set forth below.

| Temperature | |
|---|---|
| (° F.) [° C.] | SFC |
| 50 [10] | 85 |
| 68 [20] | 63 |
| 86 [30] | 26 |
| 104 [40] | <1 |

The shortening composition was melted in a kettle and feed via piston pump to the scraped-surface heat exchanger (SSHE). The SSHE had a diameter of 75 mm, a length of 300 mm, and a shaft diameter of 65 mm. The SSHE had a chromed nickel barrel. The refrigerant used in the SSHE was R404a. After the SSHE, the material was piped to a manifold with 0.15 inch (3.8 mm) holes resulting in the extrudate being in the form of rods having a diameter of 0.15 inch (3.8 mm). The residence time between the SSHE and the manifold was 4 seconds at 100 liters/hr flow rate, and 8 seconds at the 50 liters/hour flow rate. Exit temperatures from the SSHE were not directly measured (omitting the thermocouple allowed for a close mounting of the manifold to the SSHE). However, in similar experiments, exit temperatures of 60° F. to 62° F. (15.6° C. to 16.7° C.) were observed. The product was collected in 50 pound (22.7 kg) boxes. Final product temperatures were measured 3 hours after leaving the SSHE. This allows time for all the material to crystallize, and for the heat of crystallization to warm the rods to their final temperature. The boxes were stored at 70° F. (21.1° C.) for 3 days prior to observation of clumping. This simulates stacking the boxes on a pallet because, even in cold storage, the product in the center box remains warm for several days. The data from the experiments described above is summarized in the table below.

| Inlet Oil | Shaft | Material | Refrigerant | Final Product | |
|---|---|---|---|---|---|
| Temperature | Speed | Flow Rate | Temperature | Temperature | Product |
| (° F.) [° C.] | (rpm) | (liters/hour) | (° F.) [° C.] | (° F.) [° C.] | Clumping |
| 105 [40.6] | 300 | 100 | −18 [−27.8] | 73.7 [23.2] | Slight (27 lb/ft³) |
| 105 [40.6] | 300 | 100 | 0 [−17.8] | 76.9 [24.9] | None |
| | | | | | (19 lb/ft³) |
| 105 [40.6] | 300 | 50 | −18 [−27.8] | 70.7 [21.5] | None |
| | | | | | (19 lb/ft³) |

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A method for making a flaked shortening composition comprising the steps of:
(a) providing a shortening composition at a temperature above its melting point so that it is a liquid;
(b) rapidly cooling the liquid shortening composition to form a supercooled shortening composition;
(c) extruding the supercooled shortening composition through an orifice to form an extrudate comprising the supercooled shortening composition; and
(d) allowing the supercooled shortening composition to complete crystallization to form the flaked shortening composition.

2. The method of claim 1, wherein the liquid shortening composition is supercooled by passing it through one or more scraped-surface heat exchangers.

3. The method of claim 1, wherein the supercooled shortening composition is extruded onto a moving belt and is allowed to complete crystallization while in contact with the moving belt.

4. The method of claim 3, wherein the extrudate is allowed to complete crystallization in the absence of an applied cooling force.

5. The method of claim 1, wherein the extrudate is in the form of a plurality of thin sheets.

6. The method of claim 5, wherein the thin sheets have a thickness of about 0.06 inches (1.5 mm) or less; and a width of about 0.2 inches to about 1 inch (5 mm to 25.4 mm).

7. The method of claim 1, wherein the supercooled shortening composition is extruded directly into a container.

8. The method of claim 1, wherein the shortening composition comprises a base oil and a hardstock fat.

9. The method of claim 1, wherein the shortening composition has a Mettler Drop Point ranging from about 95° F. to about 140° F. (35° C. to 60° C.).

10. The method of claim 1, wherein the shortening composition is supercooled to a temperature of about 40° F. to 60° F. (4.4° C. to 15.6° C.) below the Mettler Drop Point of the shortening composition.

11. The method of claim 1, wherein the shortening composition is cooled from an initial temperature of about 105° F. (40.6° C.) or greater to a final temperature of about 65° F. (18.3° C.) or less in a time period of about 15 seconds or less.

12. The method of claim 1, wherein the method includes a heat exchanger having an outlet in fluid communication with an inlet to an extrusion manifold; and wherein there is no resting tube between the outlet of the heat exchanger and the inlet to the extrusion manifold.

13. The method of claim 1, wherein the method includes a heat exchanger having an outlet in fluid communication with an inlet to an extrusion manifold; and wherein a residence time of the shortening composition from the outlet of the heat exchanger to the inlet of the extrusion manifold is about 60 seconds or less.

14. The method of claim 1, wherein the extrusion manifold includes an outlet; and
wherein a total residence time of the shortening composition from the outlet of the heat exchanger to the outlet of the extrusion manifold is about 90 seconds or less.

15. The method of claim 13, wherein at least a portion of the shortening composition is uncrystallized when it passes through the outlet of the extrusion manifold.

16. A flaked shortening composition prepared by a method comprising the steps of:
(a) providing a shortening composition at a temperature above its melting point so that it is a liquid;
(b) rapidly cooling the liquid shortening composition to form a supercooled shortening composition;
(c) extruding the supercooled shortening composition through an orifice to form an extrudate comprising the supercooled shortening composition; and
(d) allowing the supercooled shortening composition to crystallize to form the flaked shortening composition.

17. The method of claim 16, wherein the extrudate comprises thin sheets having a thickness of about 0.06 inches (1.5 mm) or less; and a width of about 0.2 inches to about 1 inch (5 mm to 25.4 mm).

18. The method of claim 16, wherein the shortening composition has a Mettler Drop Point ranging from about 95° F. to about 140° F. (35° C. to 60° C.).

19. A dough composition comprising the flaked shortening composition of claim 16.
